(19) United States
(12) Patent Application Publication
(10) Pub. No.: US 2025/0137300 A1
(43) Pub. Date: May 1, 2025

(54) System and Method for Remotely Locking and Unlocking Vehicle Accessory Locks

(71) Applicant: The Eastern Company, Naugatuck, CT (US)

(72) Inventors: Robert L. Pliml, Lake Zurich, IL (US); Andrew J. Duvall, Avondale, PA (US)

(73) Assignee: The Eastern Company, Naugatuck, CT (US)

(21) Appl. No.: 18/931,292

(22) Filed: Oct. 30, 2024

Related U.S. Application Data
(60) Provisional application No. 63/594,797, filed on Oct. 31, 2023.

(51) Int. Cl. E05B 81/56; E05B 81/16; E05B 81/76; E05B 81/80

(52) U.S. Cl. CPC E05B 81/56; E05B 81/16; E05B 81/76; E05B 81/80

(57) ABSTRACT

The invention provides a system and method for unlocking and opening a door or window on a vehicle accessory cap, or a tonneau cover, with the vehicle having an operator, a battery for providing electric power and a vehicle door unlock signal, comprising, a first control module receiving input power from the battery and receiving the vehicle door unlock signal from the vehicle. Upon receiving the vehicle door unlock signal from the vehicle, the first control module sends a switch operable signal to a first switch, and upon activation of the switch by the vehicle operator, the first control module sends a signal to a first latch associated with the cap door or window or tonneau cover to open the cap door or window or tonneau cover. Multiple control modules may be daisy-chained. In one embodiment, the control modules receive input power, but no vehicle door unlock signal.

### CROSS-REFERENCE TO RELATED APPLICATIONS

This application claims the benefit of and priority to U.S. Provisional Patent Application No. 63/594,797, filed Oct. 31, 2023, which is incorporated by reference herein in its entirety.

### BACKGROUND

Vehicle accessories of various types provide vehicle users convenient ways to extend the usefulness of their vehicles. In many such accessories employed by users on their vehicles, the vehicle accessories include locks for securing the accessory to the vehicle and/or securing contents being stored in or on the accessories.

In at least some known vehicle accessories, accessory locks are power locks. In such examples, use of the accessory power locks may require users to carry more than one key fob with their vehicle fob and/or ignition key. In other known examples, hard wiring of each of the power accessory locks individually to the vehicle's battery or door locking and unlocking communication system requires running multiple wires through the body of the vehicle, which not only require labor-intensive procedures and numerous additional parts besides the accessory and accessory locks themselves, but also may void vehicle warranties for issues such as body corrosion.

Therefore, a need exists in the field of lockable vehicle accessories for devices, systems, and methods for remotely locking and unlocking vehicle accessory locks that provide users more convenience, are less expensive and less time-consuming to install, are easier to operate and maintain, require fewer modifications to vehicles to which they are attached and/or to the vehicle accessories themselves, and which make attaching the vehicle accessories to vehicles less likely to violate vehicle warranty conditions.

One application for the system and method is in conjunction with vehicle accessories such as doors or openings for pick-up truck bed caps or tonneau covers. In many such accessories employed by users on their vehicles, the vehicle accessories include lockable latches for securing the accessory to the vehicle and/or securing doors or windows on the accessory to protect contents being stored in or on the accessories. For example, an after-market pick-up truck cap may have a rear door that is hinged horizontally to swing upward when opened, as well as side windows that also hinge upwardly. The door and windows may have a pair of rotary latches at the lower outside corners between the door or windows and the frame of the cap. In some instances, the rear cap door may latch to the top of the tailgate or side walls of the bed of the associated truck when closed to hold the door closed. The rear corners of a tonneau cover may also have a pair of latches releasably attaching it to the pick-up truck bed. In many instances, these latches have been operated manually, and if lockable, required a manual key at the latch to lock and unlock. In some instances, a lockable center handle may be used to operate a pair of latches at the corners simultaneously. Utility body trucks also have numerous lockers with lockable doors that could be unlocked by an electrical signal.

Attempts to provide an electronic unlocking and locking of the door to a truck cap or tonneau cover are shown in commonly assigned U.S. Pat. Nos. 6,354,650 and 8,474,290. Both of these patents disclose a manually rotating handle mounted in the middle of the cap door for moving elongated rods into and out of position for maintain the door closed against the side of the cap as well as electrically operated latches at the corners.

A need exists in the field of vehicle accessory lockable latches for devices, systems, and methods for unlocking and opening such latches that provide users more convenience, are less expensive and less time-consuming to install, are easier to operate and maintain, require fewer modifications to vehicles to which they are attached and/or to the vehicle accessories themselves, and make attaching the vehicle accessories to vehicles less likely to violate vehicle warranty conditions.

### SUMMARY

The devices, systems, and methods for electrically unlocking and releasing electro-mechanical rotary latches for vehicle accessories such as doors or windows for pick-up truck caps or tonneau covers disclosed herein provide users a number of beneficial technical effects and a more desirable manufacturer and user experience as compared to known systems and methods. Such benefits include, without limitation, greater convenience, being less expensive and less time-consuming to install, being easier to operate and maintain, requiring fewer modifications to vehicles to which they are attached and/or to the vehicle accessories themselves, and making attaching the vehicle accessories to vehicles less likely to violate vehicle warranty conditions.

In one embodiment, the invention provides a system for unlocking and opening a door or window on a vehicle accessory cap, or a tonneau cover, with the vehicle having an operator, a battery for providing electric power and a vehicle door unlock signal, comprising, a first control module receiving input power from the battery and receiving the vehicle door unlock signal from the vehicle. Upon receiving the vehicle door unlock signal from the vehicle, the first control module sends a switch operable signal to a first switch, and upon activation of the first switch by the vehicle operator, the first control module sends a signal to a first latch associated with the cap door or window or tonneau cover to open the cap door or window or tonneau cover.

The system may also have a second control module, with the second control module receiving input power and a vehicle unlock signal from the first control module and sending a switch operable signal to a second switch, wherein, upon activation of the second switch by the vehicle operator, the second control module sends a signal to a second latch for opening a second cap door or window or tonneau cover.

The system may also have a third control module, with the third control module receiving input power and a vehicle unlock signal from the first control module and sending a switch operable signal to a third switch, wherein upon activation of the third switch by the vehicle operator, the third control module sends a signal to a third latch for opening a third cap door or window.

The system may also have a third control module, with the third control module receiving an input power and vehicle unlock signal from the second control module and sending a switch operable signal to a third switch, wherein upon activation of the third switch by the vehicle operator, the third control module sends a signal to a third latch for opening a third cap door or window.

The system may also provide for the vehicle to send a vehicle door lock signal to the first control module and the first control module sends an inoperable signal to the first switch and sends a signal to deactivate the first latch and the first control module also sends an inoperable signal to the second control module which sends an inoperable signal to the second switch and a signal to the second latch to deactivate the second latch.

In another embodiment, the system provides for unlocking and opening a door or window on a vehicle accessory cap, or a tonneau cover, with the vehicle having an operator, a battery for providing electric power and a vehicle door unlock signal. The system comprises a first control module receiving input power from the battery, and upon receiving input power from the battery, the first control module sends a switch operable signal to a first switch, and upon activation of the first switch by the vehicle operator, the first control module sends a signal to a first latch associated with the cap door or window or tonneau cover to open the cap door or window or tonneau cover.

Further and alternative aspects and features of the disclosed principles will be appreciated from the following detailed description and the accompanying drawings. As will be appreciated, the principles related to devices, systems, and methods for remotely locking and unlocking vehicle accessory locks are capable of being carried out in other and different embodiments and are capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a top stylized exploded view of the inventive system wired to the vehicle battery in a rest condition.

FIG. 2 is a top stylized exploded view of the inventive system wherein the vehicle fob has been pushed and the system has received an unlocked signal from the fob to activate the system.

FIG. 3 is a top stylized exploded view of the inventive system wherein the electrical switch for the left side cap window has been pushed by the operator.

FIG. 4 is a top stylized exploded view of the inventive system wherein left side cap window button has activated the associated pair of latches.

FIG. 5 is a top stylized exploded view of the inventive system rear door button has activated the associated pair of latches.

FIG. 6 is a top stylized exploded view of the inventive system wherein right side cap window button has activated the associated pair of latches.

FIG. 7 is a top stylized exploded view of the inventive system wherein the vehicle fob has been pushed and the system has received an unlocked signal from the fob to activate the system.

FIG. 8 is a top stylized exploded view of the inventive system wherein the vehicle fob has been pushed and the system has received a locked signal from the fob to lock or depower the system.

FIG. 9 is a top stylized exploded view of the inventive system wired to the vehicle battery that has returned to a rest condition similar to FIG. 1.

FIG. 10 is an electrical schematic of one embodiment of the inventive system.

FIG. 11 is a block diagram of a first embodiment of the inventive system.

FIGS. 12A-E are left, top, right, front and perspective views of a controller or control module associated with one embodiment of the inventive system.

FIG. 13A is a perspective view of push button and associated LED light for one embodiment of the inventive system.

FIG. 13B is a front view of push button and associated LED light for one embodiment of the inventive system.

FIG. 14A is perspective view of an integral electro-mechanical rotary latch associated with one embodiment of the inventive system.

FIG. 14B is perspective view of another integral electro-mechanical rotary latch associated with one embodiment of the inventive system.

FIG. 15 is a perspective view of an electro-mechanically locking handle associated with one embodiment of the inventive system.

FIG. 16 is a cut-away perspective view of a stylized latch associated with one embodiment of the inventive system.

FIG. 17 is a perspective view of the front side of an electro-mechanically locking handle on a tonneau cover with an associated key.

FIG. 18 is a perspective view of the back side of an electro-mechanically locking handle showing an electrical push button in the handle.

FIG. 19 is a perspective view showing a portion of one embodiment of the system incorporated into the rear door of a cap on a pickup truck.

FIG. 20A is a perspective view of a linear actuator and a rotary latch in a tonneau cover.

FIG. 20B is a clos-up view of the linear actuator of FIG. 20A.

FIG. 21 is a block diagram of a second embodiment of the system.

FIG. 22 is a top stylized exploded view of another embodiment of the inventive system wherein the vehicle fob has been pushed and the system has received an unlocked signal from the fob to unlock the system.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

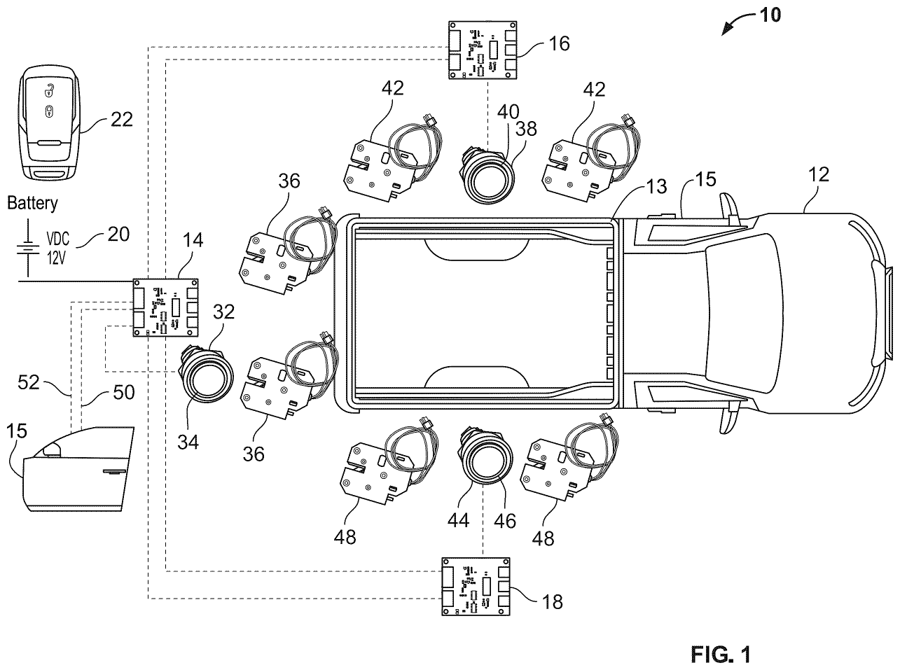

FIGS. 1-9 and 22 are stylized top views of a pickup truck 12 with various components of a couple of embodiments of the inventive system 10 positioned around the truck 12. The truck 12 includes a vehicle door 15 and a cap 13 over the bed of the pickup truck. Components of one embodiment of the system include: a first control module 14, a second control module 16, and a third control module 18. In one embodiment, the first control module 14 is associated with unlocking and opening a window or door on the back side of the cap 13, the second control module 16 is associated with unlocking and opening a window on the left side of the cap 13, and the third control module 18 is associated with unlocking and opening a window on the right side of the cap 13. Any number of control modules associated with other accessory functions can be incorporated in other embodiments of the invention.

In one embodiment, as shown in FIGS. 1-9, control module one 14 is associated with a first push button switch 32 that also has an optional first switch LED 34. When activated by the vehicle operator, the first switch 32 communicates with the control module one 14 so that control module one 14 opens a pair of electrical rotary latches 36 to allow for opening the rear window or door of the cap 13. Control module two 16 is associated with a second push button switch 38 that also has an optional second switch LED 40. When activated by the vehicle operator, the second switch 40 communicates with control module two 16 so that control module two 16 sends a signal to a pair of electrical rotary latches 42 to open a left side window of the cap 13. Control module three 18 is associated with a third push button switch 44 that also has an optional third switch LED 46. When activated by the vehicle operator, the third switch 44 communicates with control module three 18 so that control module three 18 send a signal to a pair of third electrical rotary latches 48 to open a right side window of the cap 13. Each of the electro-mechanical I rotary latches is preferably located near a lower right or left side respectively of an associated door or window of the cap 13. In some embodiments, they can also be operated mechanically as will be described below.

As shown in FIGS. 1-9 and 22, control modules two 16 and three 18 receive their electrical power and electrical signals from control module one 14. Accordingly, control module one 14 is the only control module that receives electrical power, preferably 12 volts, from the vehicle battery 20 and electrical signals 50 and 52 from the vehicle door 15 lock and unlock signals 50 and 52, simplifying wiring to the inventive system 10. As shown in the embodiments in FIGS. 1-9 and 22, one control module acts as a central hub as described above. However, the second 16 and third 18 control modules could be daisy-chained. For example, control module three 18 could receive its power and signals from control module two 16 instead of directly from control module one 14 depending on the locations of the control modules to simplify the wiring, especially the wiring of the initial control module to the electrical power and vehicle door 15 unlock 50 and lock 52 signals incorporated in the system of the truck 12.

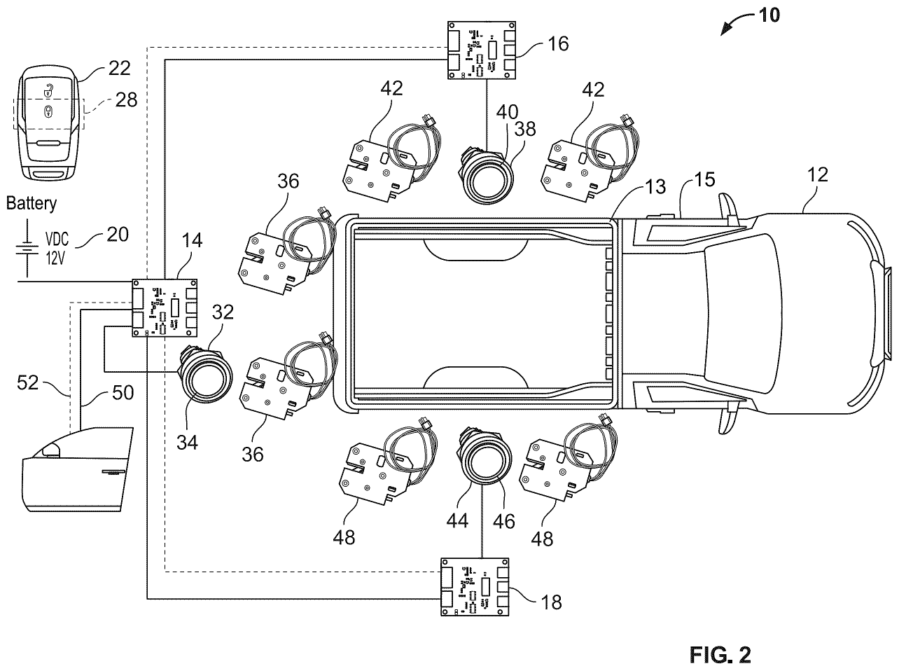

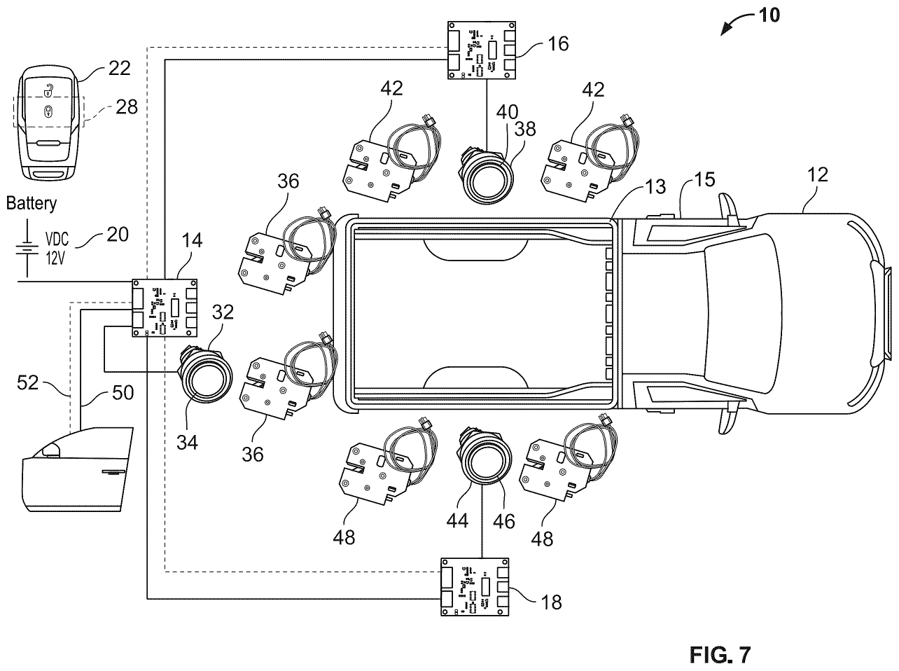

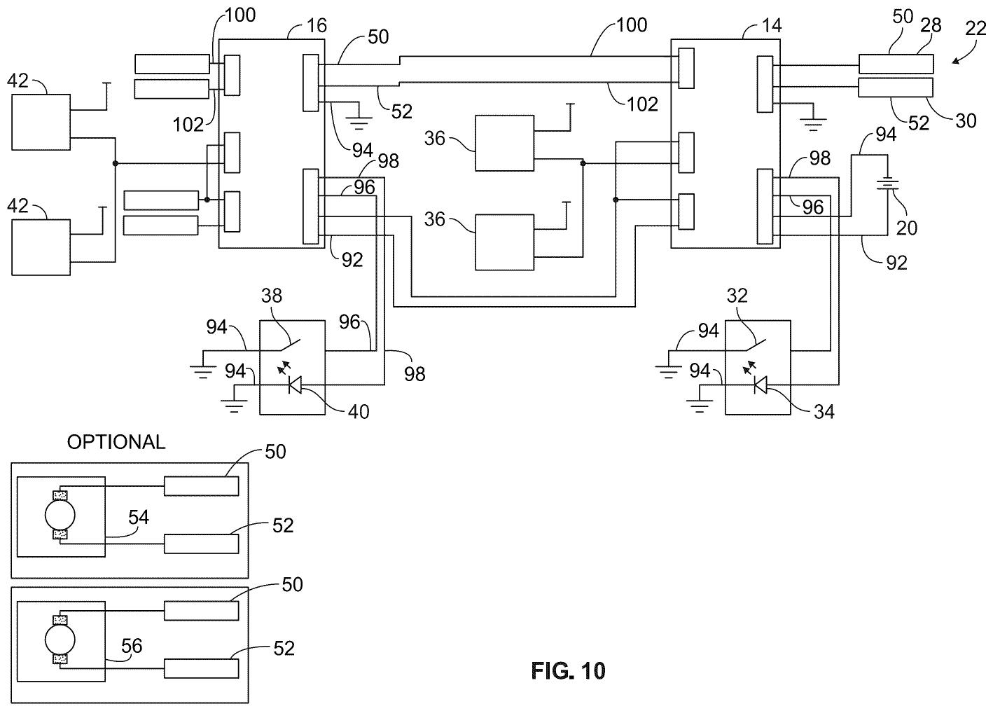

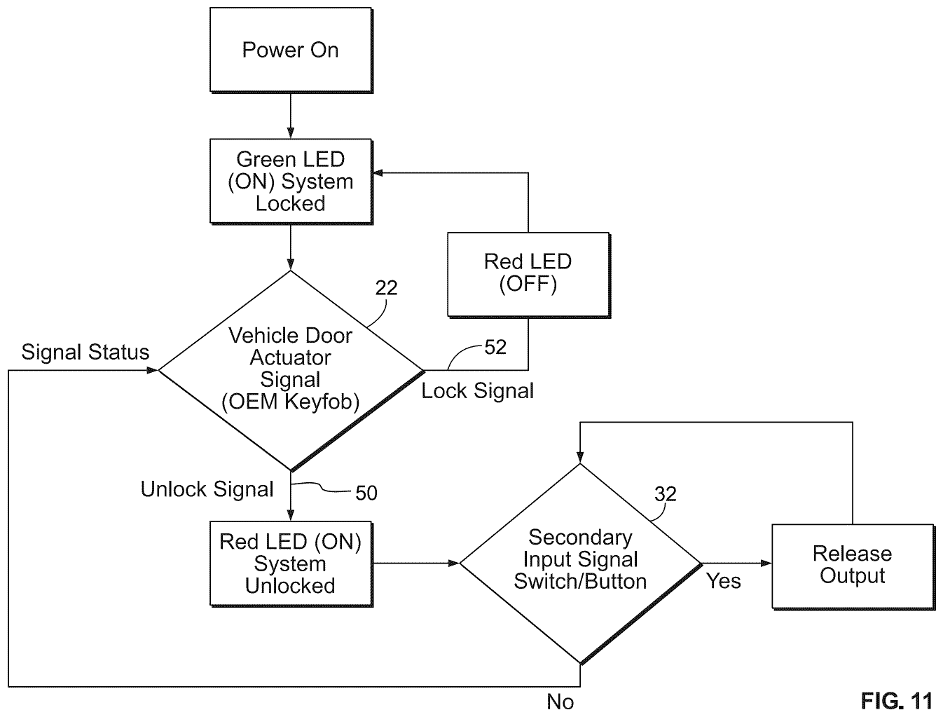

In FIG. 1, as depicted by the solid line between the battery 20 and control module one 14, the system 10 is in standby mode, with the first control module 14 receiving 12v electrical power from the vehicle battery 20, as shown in FIG. 10, and the rest of the system remains inactive. As further disclosed in FIGS. 11, 12 and 21, once the first control module 14 is connected to the battery, preferably the vehicle battery, a green light 26 is illuminated on the module along with any other control module connected to the system. In FIGS. 2 and 7, and as referenced in FIGS. 10 and 11, in one embodiment, the system 10 is initially activated by the vehicle operator pressing the unlock button 28 on the vehicle fob 22. The system 10 captures the signal in the vehicle to unlock a vehicle door 15 (or tailgate or kick panel) and provides an unlock signal 50 to the first control module 14. One system and method of capturing this signal can be found in U.S. Pat. Nos. 11,203,324 and 11,577,693 titled Systems and Methods for Remotely Locking and Unlocking Vehicle Accessory Locks and assigned to the common assignee of this application. In the current invention, the unlock signal 50 and the lock signal 52 can be daisy-chained to the second and third control modules 16 and 18, or the second 16 and third 18 control modules can both receive their unlock and lock signals directly from the first control module 14, as shown in FIG. 1.

In one embodiment, as depicted in FIG. 7, this also lights the optional LEDs 34, 40 and 46 associated with each of the push button switches 32, 38 and 44 to show the operator that they are operable and if activated (pushed), they will, through their respective control modules, activate complementary latches 36, 42 and 48 to open the respective cap 13 door or window. This also lights the red light 24 on each control module 14, 16 and 18. In one embodiment, the unlock signal 50 is communicated from the unlock controller on the door 15 of the truck. In other embodiments shown as optional in FIG. 10, the unlock signal 50 and the lock signal 52 can be communicated through a wire to the control module from the tailgate lock actuator 54 or the kick panel actuator 56 of the truck. As used herein the term vehicle door unlock 50 or lock 52 signal refers to any signal, usually associated with a fob 22 signal, to operate a lock, latch or movement from an OEM device.

Other embodiments may incorporate other communication means, such as wireless communication. Through the daisy-chaining or multiple outputs from one module, only one set of wires is required to be run from the battery 20, preferably the vehicle battery, and the lock 52 and unlock 50 controllers on the vehicle door, tailgate or kick panel to the system. Although a vehicle battery is shown in the current embodiments, it is contemplated that the system may be powered by its own battery 20 which may be rechargeable, for example by solar power.

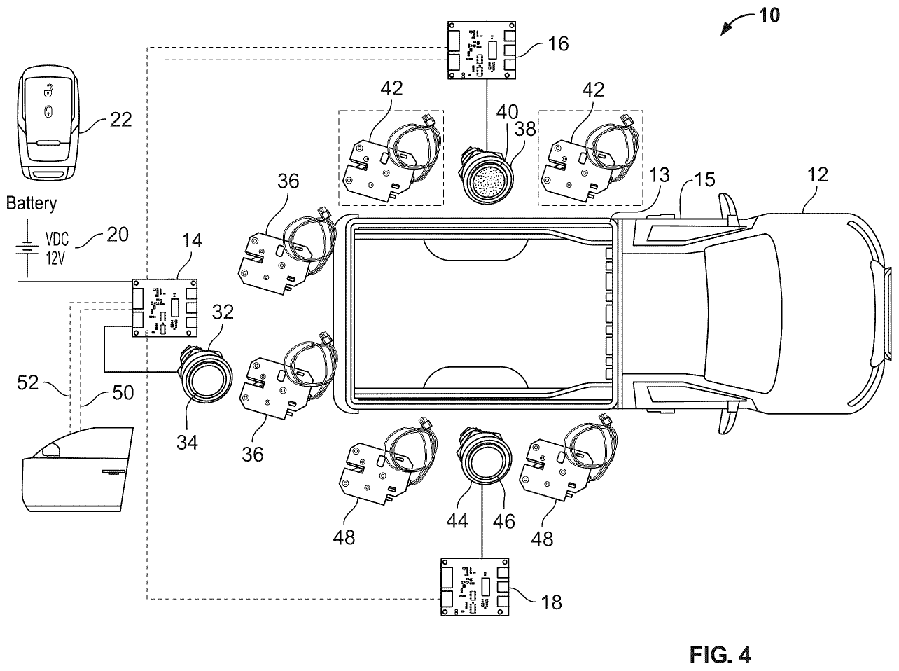

As depicted in block diagram FIG. 11, in a first embodiment, the unlock signal 50 preferably from the vehicle door 15 actuator signal generator, which may be originated from the vehicle fob 22, activates the system and turns on the red LED lights on the control modules 14 and 16 and allowing for the secondary input signal or push button switches 32 and 38 to be operable. In FIGS. 2 and 7 this is depicted by the solid lines connecting control module one 14 with control modules two and three 16 and 18 and the solid lines between each control module 14, 16 and 18 and its respective switch 32, 38 and 44. Once in the operable condition, if pushed or otherwise activated by the operator, the closing of each of the switches 32, 38 and 44 activates their respective latches 36, 42 and 48 through their respective control module to open their respective door or windows as shown in FIGS. 5, 4 and 6.

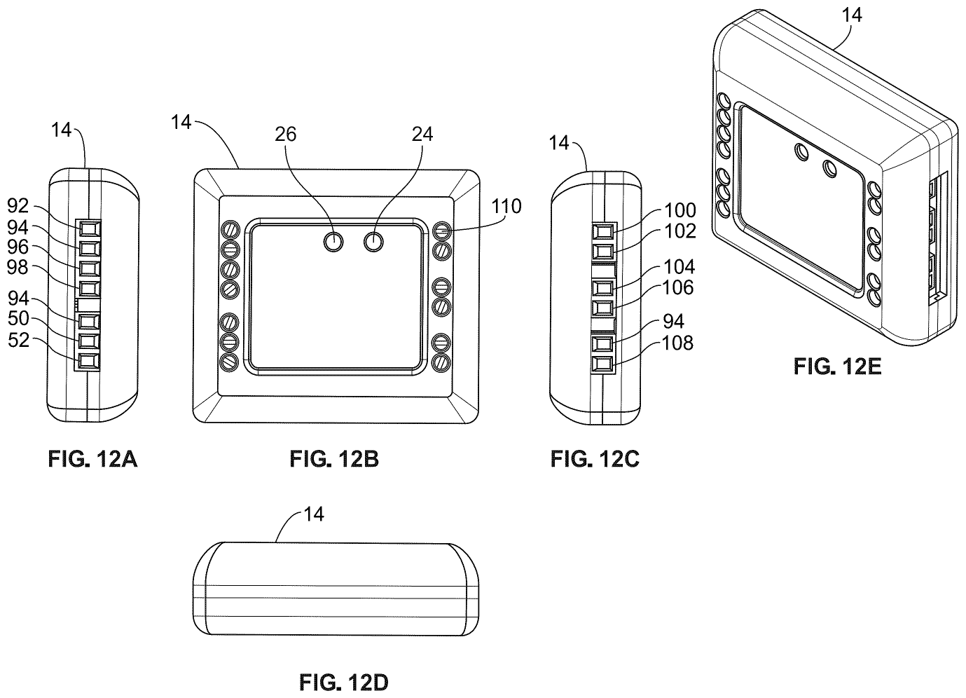

FIGS. 12A-12E show an exemplary control module 14 for one embodiment of the system 10. On the left side of the control module 14 are input terminals, including voltage in 92, ground 94, switch activation signal in 96, LED voltage out 98, unlock signal 50 and lock signal 52. On the right side of the control module 14 are outputs, including unlock out 100, lock out 102, output 104 output common 106, ground 94, and voltage out 108. Screws 110 on the top of the control module 14 clamp wires to the appropriate terminals.

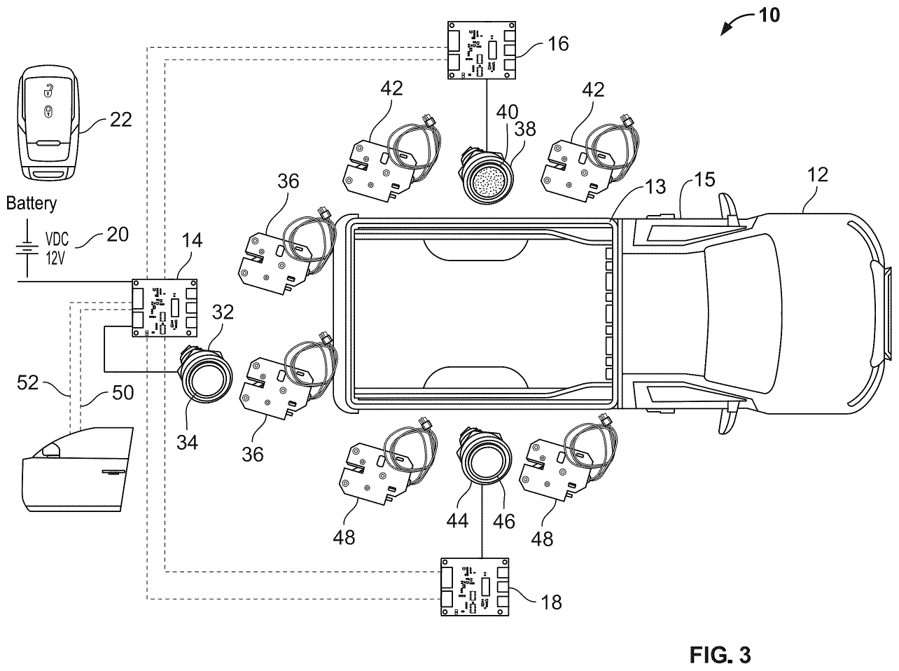

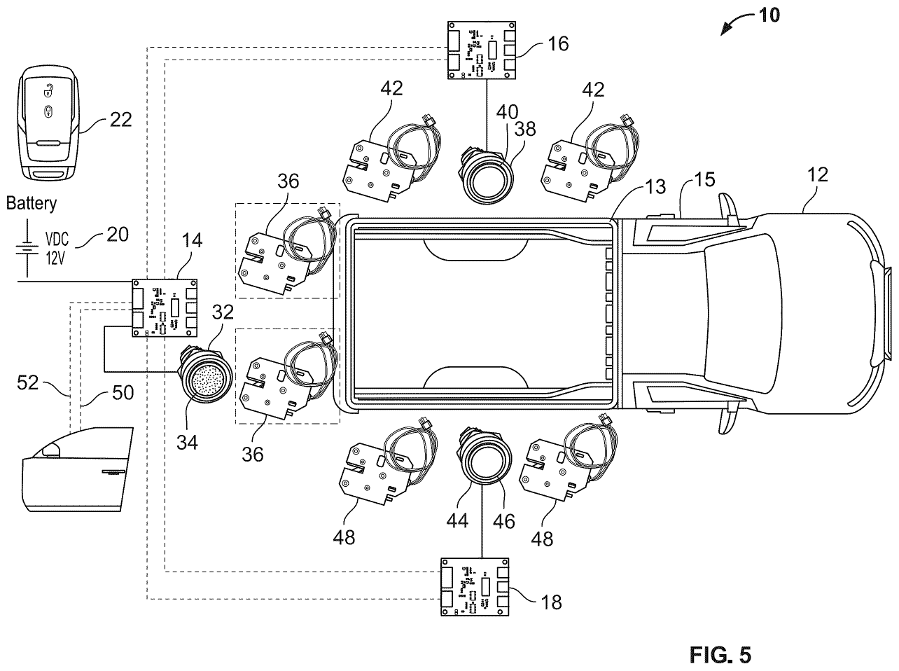

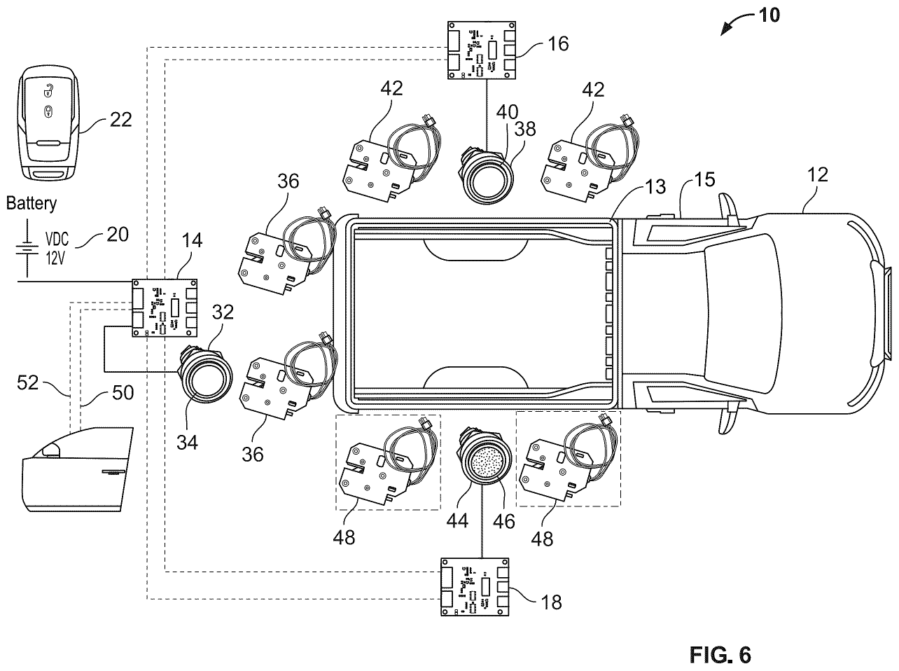

For example, in FIG. 3, the left side window switch 38 has been pressed by the operator as depicted by the shading in the switch. As shown in FIG. 10, this sends a signal beck to control module 16. As depicted in FIG. 4, this in turn sends signals to the two latches 42 shown in faint line boxes to open the left side cap window. In one embodiment, these are spring loaded latches, so the window will open slightly to allow for further opening manually by the operator. In FIG. 5, switch 32 has been pressed, which, through control module one 14 has activated latches 36 to open the rear door to the cap 13. In FIG. 6, switch 44 has been pressed, which, through control box three 18 has activated latches 48 to open the right side window of cap 13. FIG. 7 is similar to FIG. 2, but, as described above, shows the LED lights 34, 40 and 46 on the switches illuminated to show the operator that the system is enabled.

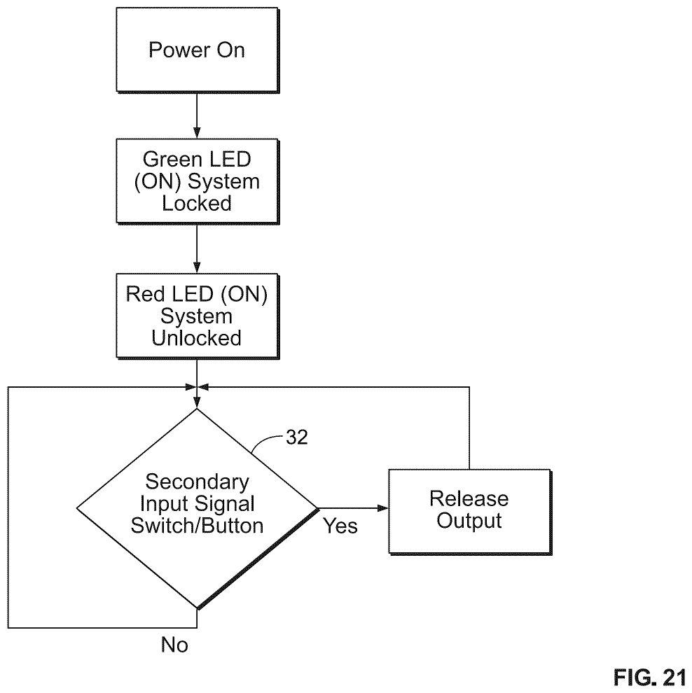

In a second embodiment, as shown in block diagram FIG. 21, the requirement for the vehicle door actuator signal is eliminated. Whenever the vehicle is powered on by the operator, the system is also powered on so that the switches 32, 38 and 44 are operable. Accordingly, when one of the switches 32, 38 or 44 is pushed or activated, the respective latch 36, 42 or 48 is also activated through their respective control module. Both the green 26 and the red 24 LEDs on the control modules are lit. In addition, in one embodiment, optional switch LEDs 36, 40 and 46 are also lit as an indicator to the operator that the system is enabled.

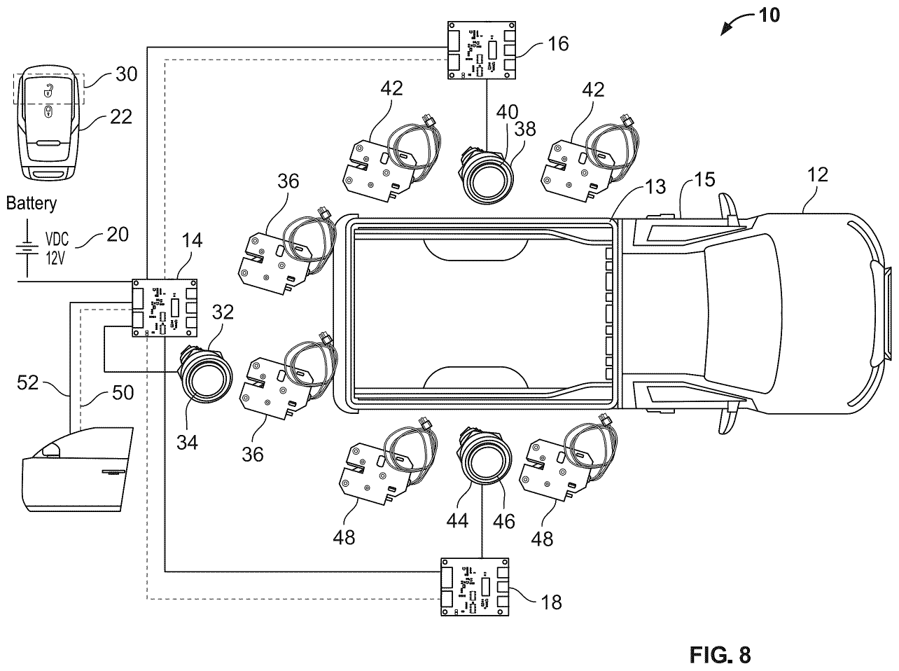

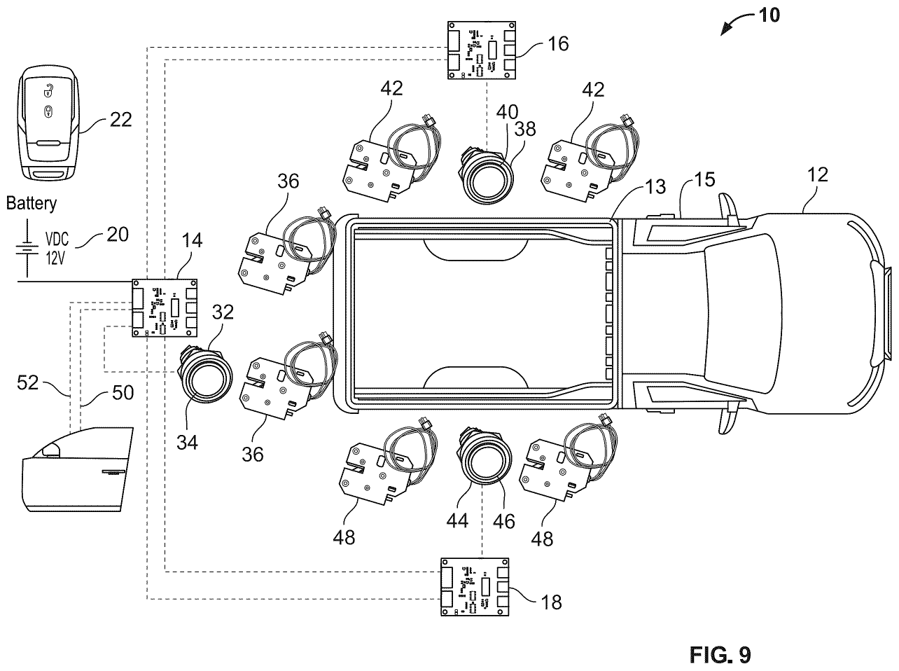

As shown in FIG. 8, if the lock button 30 is pushed on the vehicle fob, the lock signal 52 turns off the red LED 24 on the control modules and the secondary input signals and push buttons are deactivated or put in an inoperable mode as shown in FIG. 9. The switch LED's 34, 40 and 46 are also extinguished or deactivated.

The system and method may be practiced using electrical switches and latches in which the door and windows of the cap 13 or the tonneau cover 17 are unlocked and opened solely by electrical signals. Alternatively, the system and method may be practiced using switches, handles and latches in which the latches may be unlocked and opened either by electrical signals or by mechanical means as shown in the FIGS.

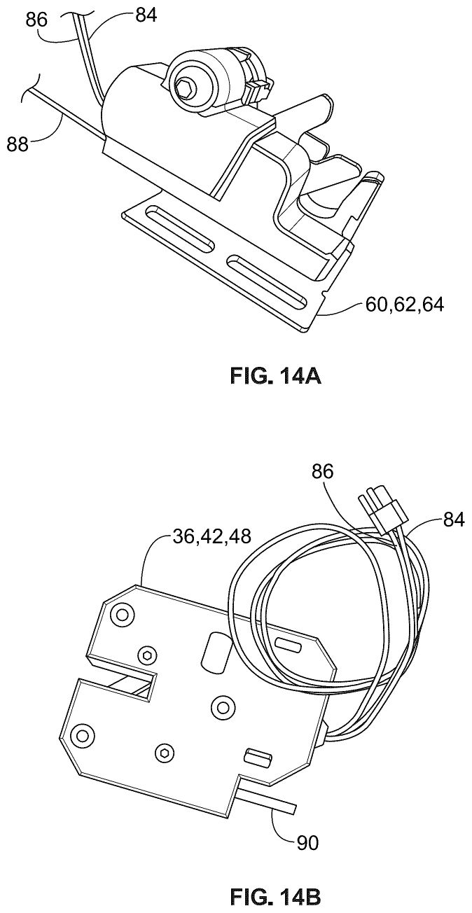

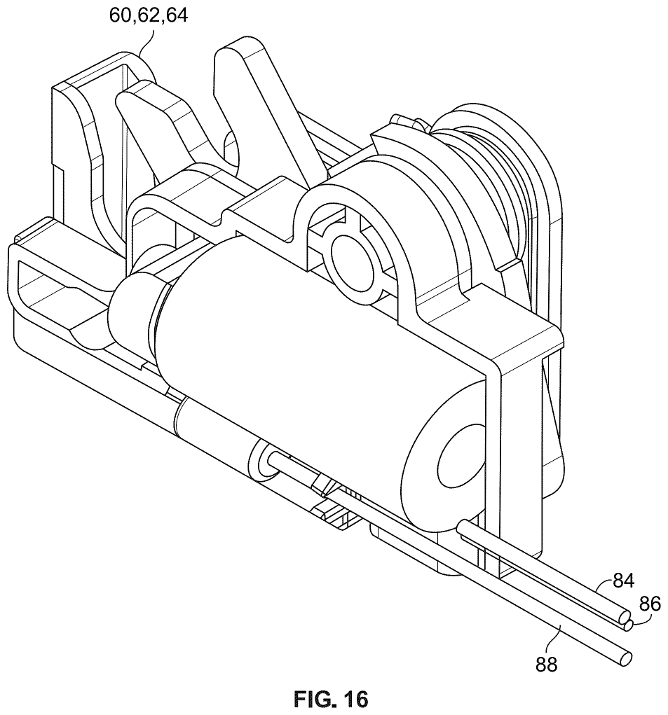

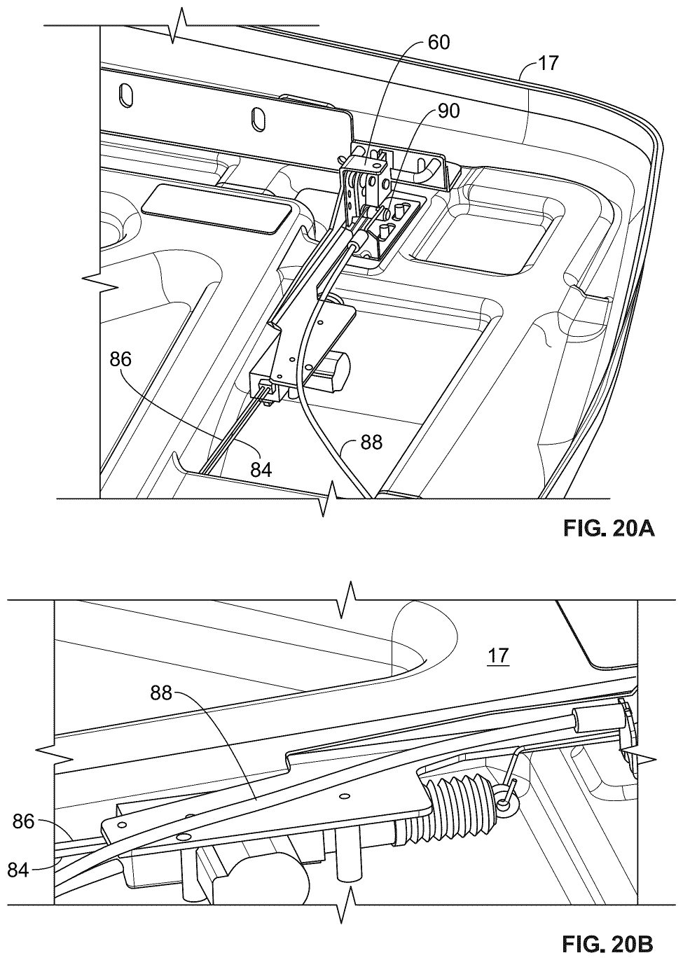

Various latches can be associated with the system 10. For example, the ES Integral Rotary Latch 60, 62, 64 sold by Eberhard Manufacturing Company shown in FIG. 14A and FIG. 16 or the ES Integral Rotary Flat Latch 36, 42, 48 also sold by Eberhard Manufacturing Company shown in FIG. 14B can be incorporated. If press to close latches, certain rotary latches, or compression latches are used in the system, upon unlocking activation of the latch, the respective cap door or window will open slightly. These types of latches will also require the operator to close the door or window manually. FIGS. 20A and B show a rotary latch 60 with an actuator for opening the latch electrically through wires 84 and 86 or a mechanical cable 88 attached to a trip lever 90 that can be pulled for opening the latch manually. Although the actuator and rotary latch are connected to a tonneau cover in these FIGS., they are also applicable to other vehicle accessories and incorporation in the system with those accessories as well. Other electronic rotary latches are contemplated to be incorporated into the system. For example, the electro-mechanical rotary latches more fully disclosed in co-pending PCT patent application PCT/US2024/030557 filed May 22, 2024, titled Electronic Rotary Latch Package, assigned to the common assignee of this application, are contemplated for inclusion into the system.

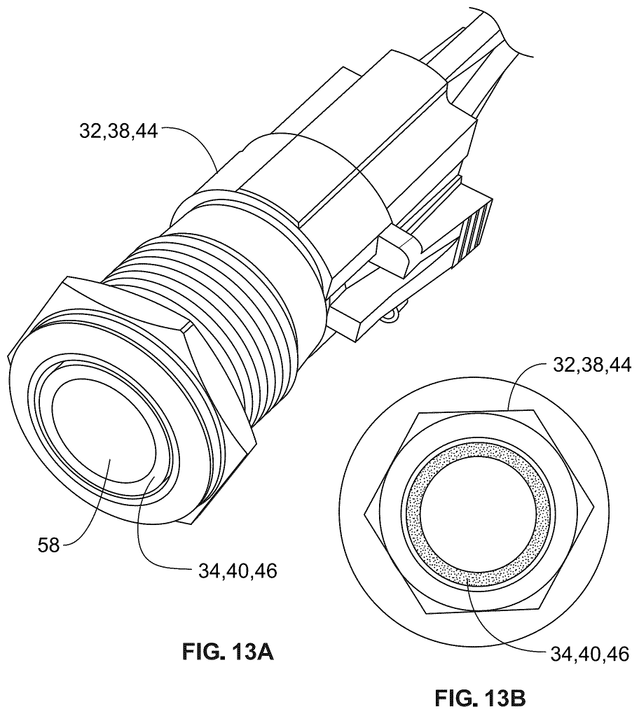

Also, a wide variety of switches can be used in the system. FIG. 13 is a perspective and front end view of the push button switches 32, 38 and 44 in FIGS. 1-9. These switches are activated by the operator pushing the center button 58 on the front end of the switch. This type of switch is incorporated into the system when the latches 36, 42 and 38 are operated only by electrical signals from the switches. They also include LED's to provide the operability indication to the operator. The LED is lit when the unlock signal 50 is transmitted to the system and extinguished when the lock signal 52 is transmitted to the system. Other types of switches, including but not limited to, optical switches, proximity switches, Hall effect switches and magnetic switches may be incorporated into the system.

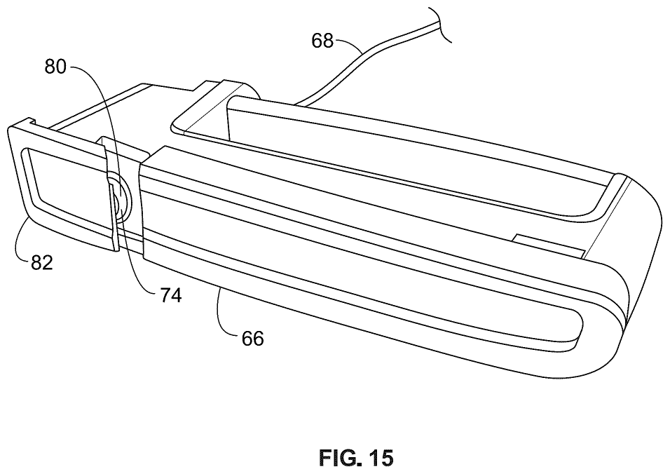

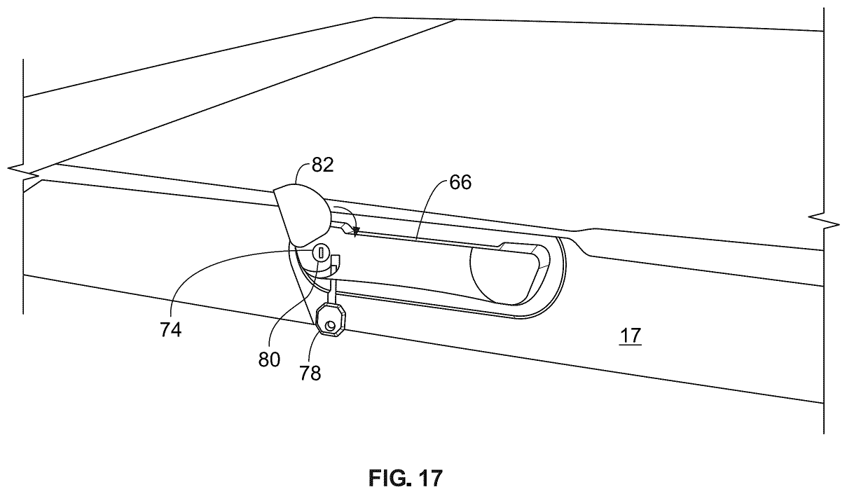

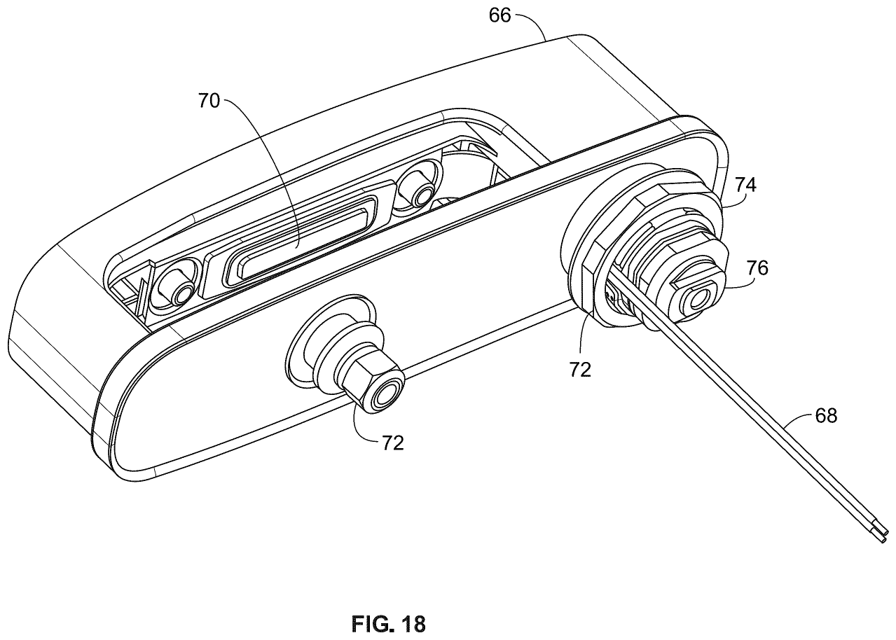

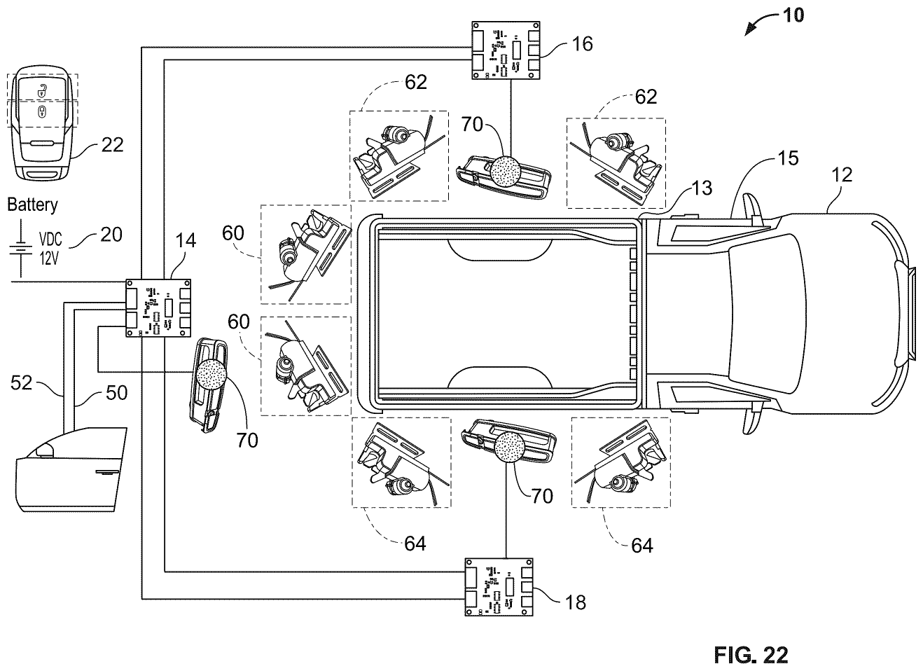

In another embodiment, as shown in FIG. 22, the latches 60, 62 and 64 similar to those shown in FIGS. 14A and 16 may be operated by an electrical signal or mechanically, preferably by a mechanical wire 88 connecting a center handle 66 keyway actuator 76 to a trip lever 90 on the latch. For example, an Active Touch Grab Handle 66 sold by Eberhard Manufacturing Company and shown in FIGS. 15 and 17-19 may be employed in the system. As best seen in FIG. 18, the Active Touch Grab Handle 66 has an electrical switch 70 on the back side of the handle that can be pushed into the handle to be activated. Since the handle 66 and switch 70 are located on the outside of the cap 13 or tonneau cover 15 the switch has a pliable plastic covering to weatherize the switch. A pair of electrical wires, 68 pass through the cap 13 door or window or tonneau cover 15 to connect the switch to the rest of the system through a control module such as control module one 14. The handle 66 is mounted on the cap 13 door or window or tonneau cover 15 by a pair of mechanical fasteners, preferably nuts on threaded stems. At least one of the threaded stems is hollow and has a cylindrical keyway 74 extending there through. An actuator 76 is located at the interior end of the keyway to rotate with the keyway 74 when an appropriate key 78 is inserted in the exterior end 80 of the keyway and rotated to rotate the keyway 74 and actuator 76. An optional cover 82 may selectively cover the exterior end 80 of the keyway 74 for weather resistance and aesthetics.

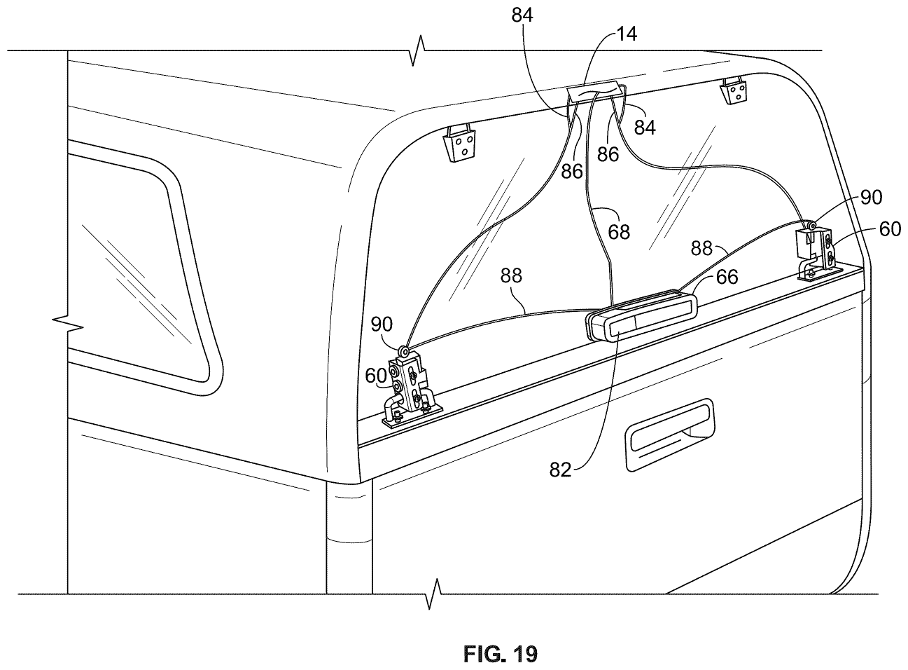

As shown in FIG. 19, in this embodiment, a pair of mechanical wires 88 extend in opposite directions from the radial extent of the actuator 76 to trip levers on each of the latches 60 associated with that handle 66. The handle is generally located in the middle of the door or window of the cap 13 or the tonneau cover while the latches are located near the outer lower corners of the cap 13 door or window or tonneau cover 15. The two latches 60 and handle 66 are connected to control module 14 by electrical wires for electrical operation of the latches by the pressing the button 70. Also, upon rotation of the key 78 and keyway 74, the actuator 76 pulls each of the wires 88 to move the trip levers 90 to open the latches and the cap door or window or tonneau cover mechanically. The latches 60 can also be opened electrically through wires 84 and 86 connecting control module 14 with the latches 60 upon receiving an activation signal from switch 70 in handle 66. FIGS. 14A and 16 are perspective views of electro-mechanical latches that may be incorporated into these types of embodiments as exemplified in FIG. 22. FIG. 14B shows an electro-mechanically activated latch that may be incorporated into embodiments utilizing flat type latches, as exemplified in FIGS. 1-9.

The various embodiments disclosed herein are to be taken in the illustrative and explanatory sense and should in no way be construed as limiting of the present disclosure. While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

We claim:

1. A system for unlocking and opening a door or window on a vehicle accessory cap, or a tonneau cover, with the vehicle having an operator, a battery for providing electric power and a vehicle door unlock signal, comprising:
a first control module receiving input power from the battery and receiving the vehicle door unlock signal from the vehicle;
upon receiving the vehicle door unlock signal from the vehicle, the first control module sending a switch operable signal to a first switch; and,
upon activation of the first switch by the vehicle operator, the first control module sending a signal to a first latch associated with the cap door or window or tonneau cover to open the cap door or window or tonneau cover.

2. The system of claim 1 also having a second control module, with the second control module receiving its input power and vehicle door unlock signal from the first control module and sending a switch operable signal to a second switch, wherein the second control module sends a signal to a second latch for opening a second cap door or window or tonneau cover upon activation of the second switch by the vehicle operator.

3. The system of claim 2 also having a third control module, with the third control module receiving its input power and vehicle door unlock signal from the first control module and sending a switch operable signal to a third switch, wherein the third control module sends a signal to a third latch for opening a third cap door or window upon activation of the third switch by the vehicle operator.

4. The system of claim 2 also having a third control module, with the third control module receiving its input power and vehicle door unlock signal from the second control module and sending a switch operable signal to a third switch, wherein the third control module sends a signal to a third latch for opening a third cap door or window upon activation of the third switch by the vehicle operator.

5. The system of claim 1 also having an LED light associated with the first switch and wherein the LED light is turned on when the switch operable signal is sent to the first switch.

6. The system of claim 1 wherein the battery is a battery associated with the vehicle for supplying power to other vehicle operations along with the system.

7. The system of claim 1 wherein the battery is a battery incorporated into the system and added to the vehicle with the system.

8. The system of claim 1 wherein the vehicle also sends a vehicle door lock signal to the first control module and the first control module sends an inoperable signal to the first switch to deactivate the first switch.

9. The system of claim 2 wherein the vehicle also sends a vehicle door lock signal to the first control module and the first control module sends an inoperable signal to the first switch which deactivates the first switch and the first control module also sends an inoperable signal to the second control module, and the second control module sends an inoperable signal to the second switch to deactivate the second switch.

10. The system of claim 5 wherein the LED light is turned off when the vehicle sends a vehicle door lock signal to the first control module.

11. The system of claim 1 with the first latch located adjacent the left side of the cap door or window or tonneau cover and also having a second latch adjacent the right side of the cap door or window or tonneau cover, and upon activation of the switch by the vehicle operator, the first control module also sending a signal to the second latch to open the cap door or window or tonneau cover.

12. The system of claim 11 also having a handle on the outside of the cap door or window or tonneau cover with the handle located between the first and second latches, the handle having a front side and a back side and the first switch is located on the backside of the handle.

13. The system of claim 12 also having a cylindrical keyway in the handle and an appropriate key for unlocking and rotating the keyway, the keyway having a key insertion end located on the outside of the cap door or window or tonneau cover and an actuator end located on the inside of the cap door or window or tonneau cover with the actuator end connected to a first end of a pair of wires with the second end of each of the pair of wires connected to a lever associated with the one of the first and second latches wherein when the appropriate key rotates the keyway, the first and second latches open the cap door or window or tonneau cover.

14. A method of unlocking and opening a door or window on a vehicle accessory cap, or a tonneau cover, with the vehicle having an operator, a battery for providing electric power and a vehicle door unlock signal, comprising the steps of:
providing a first control module receiving input power from the battery and receiving the vehicle door unlock signal from the vehicle;
upon receiving the vehicle door unlock signal from the vehicle, the first control module sending a switch operable signal to a first switch; and,
activating the first switch by the vehicle operator which sends a signal from the first control module to a first latch to open the cap door or window or tonneau cover.

15. The method of claim 14 also having a second control module, with the second control module receiving its input power and vehicle door unlock signal from the first control module comprising the steps of;
the second control module sending a switch operable signal to a second switch, and the second control module sending a signal to a second latch for opening a second cap door or window or tonneau cover upon activation of the second switch by the operator.

16. The method of claim 15 also having a third control module, with the third control module receiving its input power and vehicle door unlock signal from the first control module comprising the steps of;
sending a switch operable signal from the third control module to a third switch, and the third control module sending a signal to a third latch for opening a third cap door or window upon activation of the third switch by the operator.

17. The method of claim 15 also having a third control module, with the third control module receiving its input power and vehicle door unlock signal from the second control module comprising the steps of;
sending a switch operable signal from the third control module to a third switch, and the third control module sending a signal to a third latch for opening a third cap door or window activation of the third switch by the operator.

18. A system for unlocking and opening a door or window on a vehicle accessory cap, or a tonneau cover, with the vehicle having an operator, a battery for providing electric power and a vehicle door unlock signal, comprising:
a first control module receiving input power from the battery;
upon receiving input power from the battery, the first control module sending a switch operable signal to a first switch; and,
upon activation of the switch by the vehicle operator, the first control module sending a signal to a first latch associated with the cap door or window or tonneau cover to open the cap door or window or tonneau cover.

19. The system of claim 18 also having a second control module, with the second control module receiving its input power from the first control module and sending a switch operable signal to a second switch, wherein the second control module sends a signal to a second latch for opening a second cap door or window or tonneau cover upon activation of the second switch by the vehicle operator.

20. The system of claim 19 also having a third control module, with the third control module receiving its input power from the first control module and sending a switch operable signal to a third switch, wherein the third control module sends a signal to a third latch for opening a third cap door or window upon activation of the third switch by the vehicle operator.

21. The system of claim 18 also having a third control module, with the third control module receiving its input power from the second control module and sending a switch operable signal to a third switch, wherein the third control module sends a signal to a third latch for opening a third cap door or window upon activation of the third switch by the vehicle operator.
